(19) United States
(12) Patent Application Publication
(10) Pub. No.: US 2016/0009123 A1
(43) Pub. Date: Jan. 14, 2016

(54) DECORATIVE STICKER

(71) Applicant: JC KOREA CORP, Gyeonggi-do (KR)

(72) Inventors: Hyun Surk KIM, Gyeonggi-do (KR); Kwon-Il Kim, Gyeonggi-do (KR); Bo Mi Kim, Seoul (KR)

(73) Assignee: JC KOREA CORP, Gyeonggi-do (KR)

(21) Appl. No.: 14/737,679

(22) Filed: Jun. 12, 2015

(30) Foreign Application Priority Data
Jul. 11, 2014 (KR) 10-2014-0087774

(51) Int. Cl. B44C 1/10

(52) U.S. Cl. CPC B44C 1/105

(57) ABSTRACT

A decorative sticker is disclosed. The decorative sticker includes a substrate and a film layer attached to the substrate. The substrate includes a separable first portion and the film layer includes a separable second portion having a smaller area than the first portion.

### CROSS-REFERENCE TO RELATED APPLICATIONS

This application claims priority under 35 U.S.C. §119 to Korean Patent Application No. 10-2014-0087774 filed on Jul. 11, 2014 in the Korean Intellectual Property Office, the disclosure of which is incorporated herein by reference in its entirety.

### BACKGROUND OF THE INVENTION

1. Field of the Invention

The present invention relates to a decorative sticker.

2. Description of the Related Art

The beauty industry has been motivated by the human desire to express their physical beauty. The beauty industry has developed rapidly and been subdivided into various branches of industry, Along with the popularization of the beauty industry, the market for the beauty industry has been expanding rapidly, particularly since the 20th century.

For example, when a user intends to improve the shapes of the ⁻users fingernail, the user applies manicure to the fingernail to obtain a desired design. This work is called “nail art”. However, the spreading of a solution, such as manicure, on fingernails for nail art is not only cumbersome and laborious but also requires much time to dry the solution. Further, when a user directly performs nail art on the user's fingernails, the shapes of the fingernails after nail art may be non-uniform depending on whether the user is left-handed or right-handed.

Many efforts to solve such problems have been made. For example, people visit professional shops, such as nail shops, and request nail art to improve the shapes of their fingernails. In this case, however, service expenses should be paid to French nail art experts whenever users receive the service, imposing an economic burden on the users. For this reason, the market for decorative stickers that are easy for unskilled persons to attach to nails is steadily growing.

However, decorative stickers according to the prior art are troublesome in that users should separate substrates from the stickers by scraping with their fingernails or suitable tools. During this separation, there also exists a risk of damage to or contamination of the stickers, particularly the rims thereof.

### PRIOR ART DOCUMENTS

### Patent Documents

(Patent Document 1) KR 10-2014-0009772 A

### SUMMARY OF THE INVENTION

The present invention has been made in an effort to solve the problems of the prior art, and one aspect of the present invention is to provide a decorative sticker whose substrate is easy to remove before use without the risk of damage to or contamination of the sticker, particularly the rim thereof.

One embodiment of the present invention provides a decorative sticker including a substrate and a film layer attached to the substrate wherein the substrate includes a separable first portion and the film layer includes a separable second portion having a smaller area than the first portion.

The film layer includes a pressure-sensitive adhesive layer and o base film disposed on the pressure-sensitive adhesive layer.

The decorative sticker further includes a decorative part arranged on the upper surface of the base film disposed in the second portion.

The first portion has a shape corresponding to the shape of the second portion.

The substrate has a first connection portion where a cutting line formed along the rim of the first portion is to be cut

The film layer has a second connection portion where a cutting line formed along the rim of the second portion is to be cut.

The connection force of the second connection portion is greater than the pressure-sensitive adhesive force between the pressure-sensitive adhesive layer and the first portion.

The pressure-sensitive adhesive force between the pressure-sensitive adhesive layer and an adherend is greater than the connection force of the second connection portion.

The decorative part is made of a. resin selected from epoxy resins, silicone resins, epoxy-silicone resins, acrylic resins, urethane resins, acrylic-urethane resins, and acrylic-epoxy resins.

The features and advantages of the present invention will become more apparent from the detailed description set forth below with reference to the appended drawings.

Prior to the detailed description of the invention, it should be understood that the terms and words used in the specification and claims are not to be construed as having common and dictionary meanings, but are construed as having meanings and concepts corresponding to the spirit of the invention in view of the principle that the inventor can define properly the concept of the terms and words in order to describe his/her invention with the best method.

The substrate can be easily separated from the sticker of the present invention by a user.

In addition, the sticker, particularly the rim thereof, can be effectively protected from damage to or contamination when a user separates the substrate from the sticker.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 are cross-sectional views of a decorative sticker according to an embodiment of the present invention;

FIG. 3 is a perspective view of a decorative sticker according to an embodiment of the present invention;

FIG. 4 is a cross-sectional view of a decorative sticker according to a further embodiment of the present invention;

FIG. 5 is a perspective view of a decorative sticker according to a further embodiment of the present invention;

FIG. 6 shows perspective views for explaining a procedure for attaching decorative sticker to an adherend; and

FIG. 7 shows cross-sectional views for explaining a procedure for attaching a decorative sticker to an adherend.

### DETAILED DESCRIPTION OF THE INVENTION

The objects, certain advantages, and novel features of the present invention will become more apparent from the following detailed description and preferred embodiments when taken in conjunction with the accompanying drawings. It should be noted that, wherever possible, the same elements are denoted by the same reference numerals even though they are depicted in different drawings. Although the terms “first”, “second”, etc. may be used herein to describe various elements, these elements should not be limited by these terms. These terms are only used to distinguish one element from another. In the description of the present invention, certain detailed explanations of related art are omitted when it is deemed that they may unnecessarily obscure the essence of the invention.

Preferred embodiments of the present invention will now be described in detail with reference to the accompanying drawings.

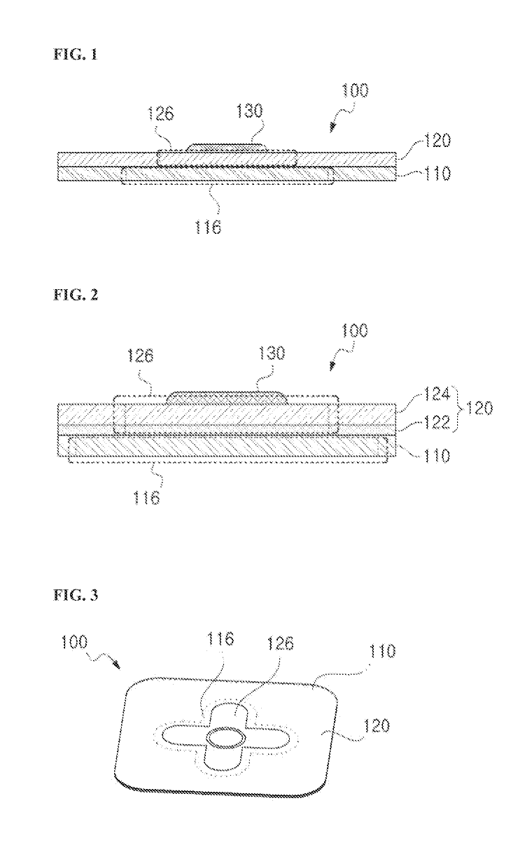

FIGS. 1 and 2 are cross-sectional views of a decorative sticker according to an embodiment of the present invention.

As illustrated in FIGS. 1 and 2, the decorative sticker 100 includes a substrate 110 and a film layer 116 attached to the substrate 110. The substrate 110 includes a separable first portion 116 and the film layer 116 includes a separable second portion 126 having a smaller area than the first portion 116.

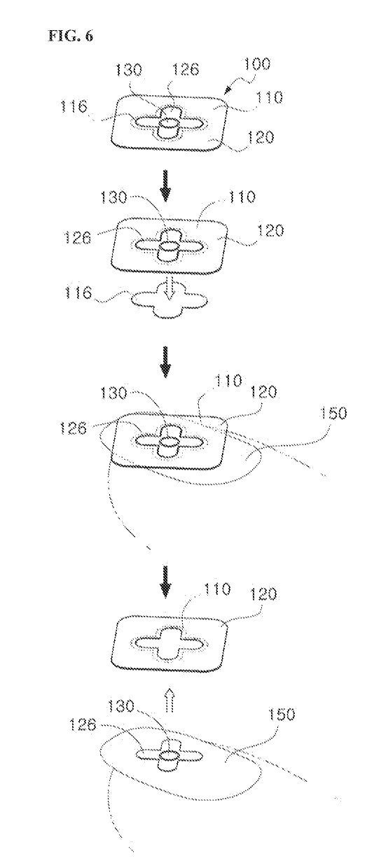

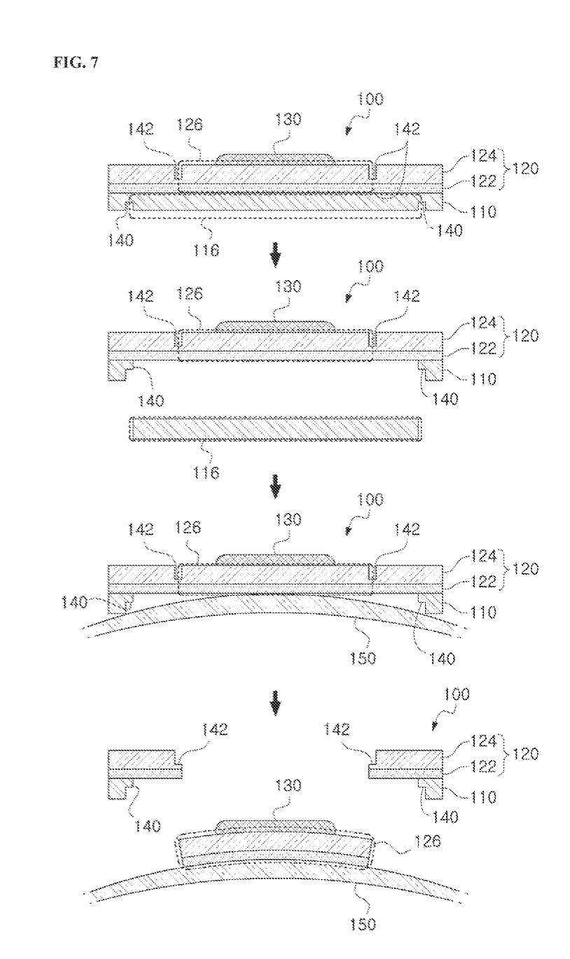

The substrate 110 serves to provide a space where the film layer 120 is attached during production of the decorative sticker while protecting the film layer 120 until use of the decorative sticker. The substrate 110 may include a release paper layer that plays a role in protecting a pressure-sensitive adhesive layer 122 until the sticker is attached to an adherend 150 (see FIGS. 6 and 7). The release paper layer is preferably formed of a material that can be easily removed from the pressure-sensitive adhesive layer 122, thus being convenient for a user to use. The material for the release paper layer is not particularly limited and is for example selected from polyethylene terephthalate (PET), polypropylene (PP), and combinations thereof. The surface of release paper layer opposing the pressure-sensitive adhesive layer may be matted to impart slip properties to the release paper layer. This matting enables the release paper layer to effectively pass through an automatic printing machine during production of the sticker while preventing the release paper layer from being attached to release paper layers of adjacent products.

The separable first portion 116 of the substrate 110 plays a role in protecting the pressure-sensitive adhesive layer 122 formed in the second portion 126, which is to attached to the adherend 150, until a user uses the sticker (see FIGS. 6 and 7).

The film layer 120 serves to provide a space where a decorative part 130 can be formed. The film layer 120 can be attached to the substrate 110. The separable second portion 126 of the film layer 120 can be attached to the adherend 150 (see FIGS. 6 and 7). The second portion 126 may be formed so as to have a smaller area than the first portion 116, and details associated with the shapes of the first and second portions 116 and 126 will be provided below.

As illustrated in FIG. 2, the film layer 120 may include the pressure-sensitive adhesive layer 122 and a base film 124 disposed on the pressure-sensitive adhesive layer 122.

The pressure-sensitive adhesive layer 122 serves to adhere the second portion 126 to the adherend 150 (see FIGS. 6 and 7). The material for the pressure-sensitive adhesive layer is not particularly limited and may be, for example, a pressure-sensitive adhesive (PSA). PSA refers to a material whose pressure-sensitive adhesiveness is generated under pressure and is used to adhere the second portion 126 to the adherend 150.

The base film 124 serves to provide a space for the formation of the decorative part 130, which will be explained below. The base film 124 is disposed on the pressure-sensitive adhesive layer 122 and is attached to the adherend 150 when used (see FIGS. 6 and 7). The base film 124 may have a planar shape that can generate a two-dimensional representation. The decorative part 130 per se is not directly attached to the adherend 150 and is attached to the planar base film 124, which is then attached to the adherend 150. Accordingly, even when the decorative part 130 has a three-dimensional shape instead of a two-dimensional shape, the decorative part 130 can be stably attached to the adherend 150 by the use of the planar base film 124. However, the base film 124 is not necessarily limited to a planar shape.

As illustrated in FIG. 2, the decorative sticker 100 further includes the decorative part 130 arranged on the upper surface of the base film 124 disposed in the second portion 126.

The decorative part 130 serves to exhibit a decorative effect on the adherend 150. The decorative part 130 may have various shapes. For example, the decorative part 130 has a two- or three-dimensional shape. The decorative part 130 may be made of a resin selected from epoxy resins, silicone resins, epoxy-silicone resins, acrylic resins, urethane resins, acrylic-urethane resins, and acrylic-epoxy resins.

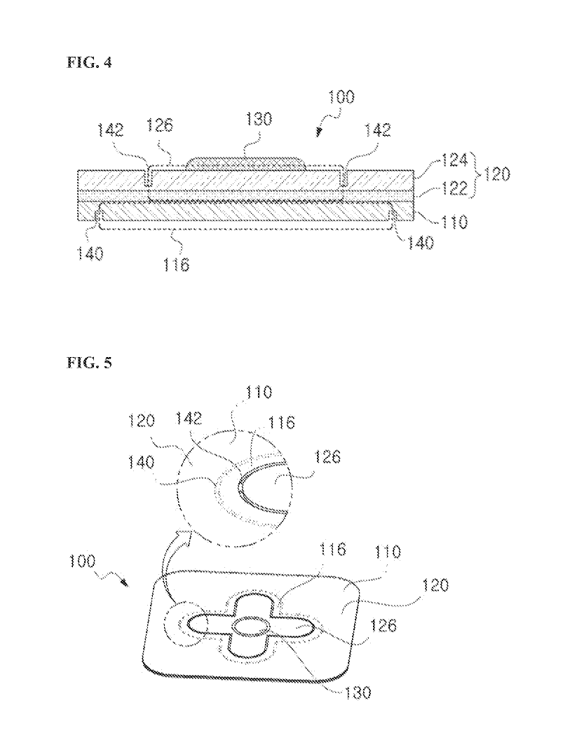

FIG. 3 is a perspective view of a decorative sticker according to an embodiment of the present invention.

As illustrated in FIG. 3, the second portion 126 has a smaller area than the first portion 116 and has a shape corresponding to the shape of the first portion 116. Specifically, the rim of the first portion 116 is spaced radially outward from the rim of the second portion 126 such that the shapes of the first and second portions 116 and 126 correspond to each other. That is, the rim of the first portion 116 does not cross the rim of the second portion 126 and is not included in the inner area of the second portion 126. With this arrangement, when the decorative sticker 100 of the present invention is attached to the adherend 150, the entire area of the second portion 126 can be attached to the adherend 150, and as a result, the second portion 126 can be easily separated from the film layer 120 (see FIGS. 6 and 7).

FIGS. 4 and 5 are a cross-sectional view and a perspective view of a decorative sticker according to a further embodiment of the present invention, respectively.

The first portion 116 of the substrate 110 is maintained attached to the film layer 120 until a force is applied thereto and is detached from the film layer 120 when a predetermined force is applied thereto. For this detachment, the force to release the substrate 110 or the pressure-sensitive adhesive strength of the pressure-sensitive adhesive layer 122 of the film layer 120 needs to be controlled.

As illustrated in FIGS. 4 and 5, a cutting line may be formed in the substrate 110 along the rim of the first portion 116. Additionally, a first connection portion 140 is formed where the cutting line formed along the rim of the first portion 116 is to be cut. By the first connection portion 140, the first portion 116 can be connected to the substrate 110 in a bridge structure. That is, the first portion 116 is maintained connected to the other area of the substrate 110 positioned radially from the first portion 116 until a force is applied thereto and is easily detachable from the film layer 120 when a user applies a force thereto. The cutting line is connected in the first connection portion 140, as observed visually. As illustrated in FIG. 4, the substrate 110 is cut to a predetermined depth to form the first connection portion 140 through which the first portion 116 is connected to the other area of the substrate 110 positioned radially from the first portion 116. Alternatively, no cutting line may be observed visually in the first connection portion 140.

As illustrated in FIGS. 4 and 5, a second connection portion 142 is formed where a cutting line formed along the rim of the second portion 126 is to be cut. By the second connection portion 142, the second portion 126 can be connected to the film layer 120 in a bridge structure. That is, the first portion 116 is maintained connected to the other area of the substrate 110 positioned radially from the first portion 116 until a force is applied thereto. Thus, the second portion 126 can be easily separated from the film layer 120 when a user applies a force thereto.

On the other hand, when a user applies a force to remove the first portion 116 from the substrate 110, the second portion 126 should remain unremoved from the film layer 120. To this end, the sticker may be designed such that the connection force of the second connection portion 142 is different from the pressure-sensitive adhesive force between the pressure-sensitive adhesive layer 122 formed on the lower surface of the second portion 126 and the first portion 116.

Specifically, the connection force of the second connection portion 142 may be greater than the pressure-sensitive adhesive force between the pressure-sensitive adhesive layer 122 formed on the lower surface of the second portion 126 and the first portion 116. As a result, the first portion 116 is detached from the pressure-sensitive adhesive layer 122 but the second portion 126 is maintained connected to the film layer 120 without being removed from the film layer 120 (see FIGS. 6 and 7).

After the second portion 126 on which the decorative part 130 is formed is attached to the adherend 150, the second portion 126 needs to be easily separated from the film layer 120. To this end, the sticker may be designed such that the connection force of the second connection portion 142 is different from the pressure-sensitive adhesive force between the pressure-sensitive adhesive layer 122 formed on the lower surface of the second portion 126 and the adherend 150.

Specifically, the connection force of the second connection portion 142 ma be greater than the pressure-sensitive adhesive force between the pressure-sensitive adhesive layer 122 formed on the lower surface of the second portion 126 and the adherend 150. As a result, the second portion 126 is maintained attached to the adherend 150 and the second portion 126 can be separated from the film layer 120. Consequently, the second portion 126 only can be attached to the adherend 150. Thus, the decorative effect of the decorative part 130 disposed on the second portion 126 can be obtained (see FIGS. 6 and 7).

FIGS. 6 and 7 are perspective views and cross-sectional views for explaining a procedure for attaching the decorative sticker to the adherend, respectively.

The procedure will be specifically explained with reference to FIGS. 6 and 7. The adherend 150 may be exemplified by, but is not necessarily limited to, a fingernail

First, the first portion 116 can be removed from the substrate 110 by cutting the first connection portion 140. Then, the pressure-sensitive adhesive layer 122 arranged on the lower surface of the second portion 126 is brought into contact with the adherend 150 and a force is applied thereto. At this time, the pressure-sensitive adhesive layer 122 can be attached to the adherend 150 due to its pressure-sensitive adhesive strength. The pressure-sensitive adhesive layer 122 may be composed of a pressure-sensitive adhesive material, such as a PSA, as described above.

After the pressure-sensitive adhesive layer 122 is sufficiently attached to the adherend 150, a force is applied to the substrate 110 in the opposite direction toward the adherend 150. The second connection portion 142 is cut and only the second portion 126 is left attached to the adherend 150 because the pressure-sensitive adhesive force between the pressure-sensitive adhesive layer 122 and the adherend 150 is larger than the connection force of the second connection portion 142.

The present invention has been described in detail with reference to its specific embodiments. These embodiments are provided for illustrative purposes and are not intended to limit the invention. It should be understood that various modifications and improvements can be made by those skilled in the art without departing from the spirit of the invention.

What is claimed is:

1. A decorative sticker comprising a substrate comprising a separable first portion and a film layer attached to the substrate and comprising a separable second portion having a smaller area than the first portion wherein the film layer comprises a pressure-sensitive adhesive layer and a base film disposed on the pressure-sensitive adhesive layer, the substrate has a cutting line formed along the rim of the first portion, and the film layer has a cutting line formed along the rim of the second portion and a second connection portion, where the cutting line is to be cut, through which the portion of the film layer outside the second portion is connected to the portion of the film layer inside the second portion.

2. The decorative sticker according to claim 1, further comprising a decorative part arranged on the upper surface of the base film disposed in the second portion.

3. The decorative sticker according to claim 1, wherein the first portion has a shape corresponding to the shape of the second portion.

4. The decorative sticker according to claim 1, wherein the substrate has a first connection portion where the cutting line formed along the rim of the first portion is to be cut

5. The decorative sticker according to claim 1, wherein the connection force of the second connection portion is greater than the pressure-sensitive adhesive force between the pressure-sensitive adhesive layer and the first portion.

6. The decorative sticker according to claim 1, wherein the pressure-sensitive adhesive force between the pressure-sensitive adhesive layer and an adherend is greater than the connection force of the second connection portion.

7. The decorative sticker according to claim 2, wherein the decorative part is formed of a resin selected from epoxy resins, silicone resins, epoxy-silicone resins, acrylic resins, urethane resins, acrylic-urethane resins, and acrylic-epoxy resins.
